(19) United States
(12) Patent Application Publication
(10) Pub. No.: US 2013/0223692 A1
(43) Pub. Date: Aug. 29, 2013

(54) METHOD FOR LOGO DETECTION IN MEMC

(71) Applicants: Yu-Shu Liu, Hsinchu City (TW); Chun-Wei Chen, Taipei City (TW); Jian-De Jiang, Shaanxi Province (CN)

(72) Inventors: Yu-Shu Liu, Hsinchu City (TW); Chun-Wei Chen, Taipei City (TW); Jian-De Jiang, Shaanxi Province (CN)

(73) Assignee: NOVATEK MICROELECTRONICS CORP., Hsinchu (TW)

(21) Appl. No.: 13/456,237

(22) Filed: Apr. 26, 2012

(30) Foreign Application Priority Data
Feb. 24, 2012 (TW) 101106296

(51) Int. Cl. G06K 9/48; G06K 9/00

(52) U.S. Cl. 382/107

(57) ABSTRACT

A method for detecting a static logo is provided. The method includes following steps. An edge detection is performed on each of a plurality of blocks to be detected in an image frame so as to obtain edge detection information. A motion estimation is performed on a plurality of blocks within a respective surrounding area of each of the blocks to be detected so as to obtain distribution information of motion vectors. Whether a logo is a static logo is determined according to the edge detection information and the distribution information of motion vectors. Accuracy of the logo detection can be increased by using the method.

### CROSS-REFERENCE TO RELATED APPLICATION

This application claims the priority benefit of Taiwan application serial no. 101106296, filed on Feb. 24, 2012. The entirety of the above-mentioned patent application is hereby incorporated by reference herein and made a part of this specification.

### BACKGROUND OF THE DISCLOSURE

1. Field of the Disclosure

The disclosure relates to an image processing method. Particularly, the disclosure relates to a logo detection method adapted to a motion estimation device.

2. Description of Related Art

Generally, an image frame may include a static object, and brightness, a color, a pattern and a position of the static object are maintained unchanged within a rather long time, for example, a logo contained in image frames transmitted during television (TV) channel broadcasting, which is used as a TV channel identification (ID).

During image frame processing, the static object and a moving object have to be separated. Therefore, an image processing device generally performs a “logo detection” on the image frame to detect various image information of the static object in the image frame, such as brightness, color, pattern and location, etc., and provides the image information to an internal circuit for a next stage processing.

However, during the logo detection, a part of image information of the frame can influence correctness of the detection, for example, a relationship between an edge of the moving object and a moving direction thereof, and distribution of surrounding motion vectors of the logo to be detected may all cause misjudgment of false static state and misjudgment of the logo during the logo detection. Therefore, it is necessary to provide a method for detecting a static logo to avoid misjudgment of the detection.

### SUMMARY OF THE DISCLOSURE

The disclosure is directed to a method for detecting a static logo, by which misjudgment in logo detection is avoided.

The disclosure provides a method for detecting a static logo. The method includes following steps. An edge detection is performed on each of a plurality of blocks to be detected in an image frame so as to obtain edge detection information. A motion estimation is performed on a plurality of blocks within a respective surrounding area of each of the blocks to be detected so as to obtain distribution information of motion vectors. It is determined whether a logo to be detected in the image frame is a static logo according to the edge detection information and the distribution information of motion vectors.

According to the above descriptions, in the method for detecting the static logo, the logo detection is performed by using the edge detection information and the distribution information of motion vectors of the surrounding area, so that accuracy of the logo detection is increased to avoid misjudgment.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a functional block diagram of a motion estimation and motion compensation (MEMC) device according to an embedment of the disclosure.

FIG. 2 is a flowchart illustrating a method for detecting a static logo according to an embodiment of the disclosure.

FIG. 3 is an example of a part of an image frame when a logo detection unit performs logo detection.

FIG. 4 is an example of a plurality of selected blocks when a logo detection unit performs logo detection.

FIG. 5 is another example of a plurality of selected blocks when a logo detection unit performs logo detection.

### DETAILED DESCRIPTION OF DISCLOSED EMBODIMENTS

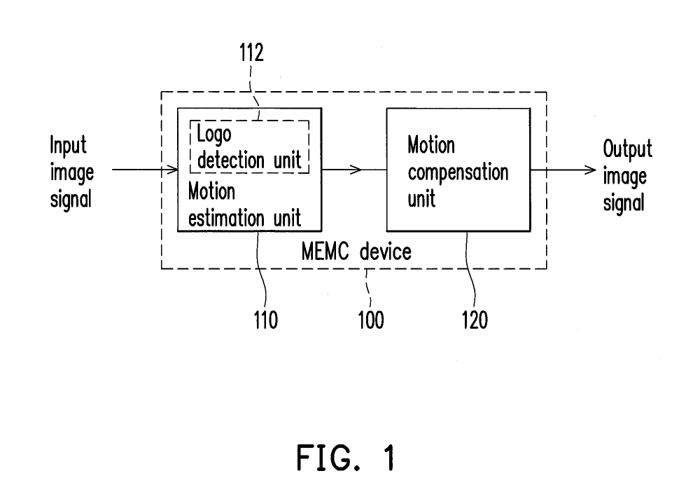

FIG. 1 is a functional block diagram of a motion estimation and motion compensation (MEMC) device according to an embedment of the disclosure. Referring to FIG. 1, in the present embodiment, the MEMC device 100 includes a motion estimation unit 110 and a motion compensation unit 120, and is used for performing motion estimation and motion compensation on an input image signal to output an image signal. The motion estimation unit 110 includes a logo detection unit 112, which is used for performing a logo detection on the input image signal.

Moreover, in order to avoid misjudgment of the detection, after a detection result of a static logo is obtained, the logo detection unit 112 provides the detection result to the motion compensation unit 120 or a next stage circuit. The motion compensation unit 120 or the next stage circuit determines whether or not to modify the detection result of the static logo or perform a logo compensation step, so as to protect the detected logo. For example, the logo compensation step is, for example, to perform image processing on the static logo such that the static logo may present better image quality on a screen.

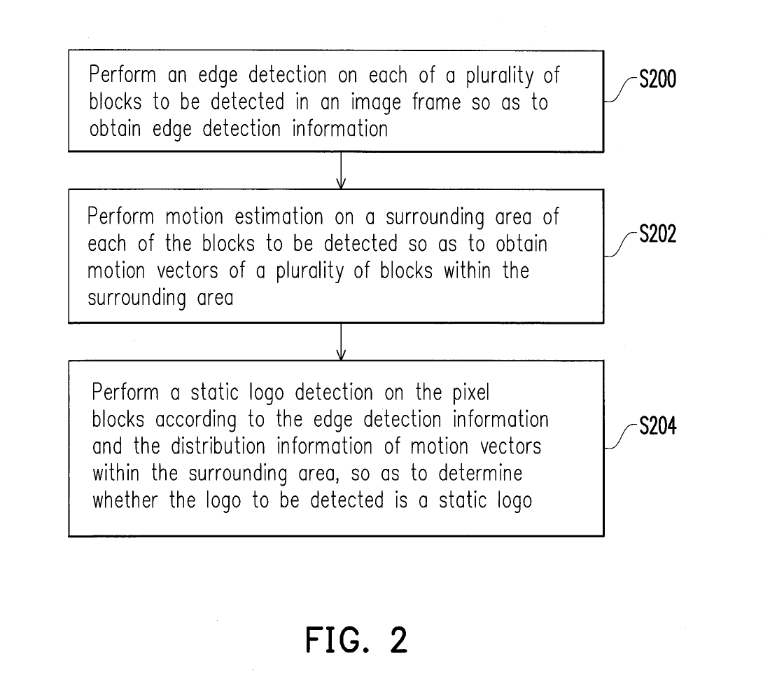

FIG. 2 is a flowchart illustrating a method for detecting a static logo according to an embodiment of the disclosure. Referring to FIG. 1 and FIG. 2, in the present embodiment, the method for detecting the static logo is, for example, adapted to the MEMC device shown in FIG. 1.

In step S200, the logo detection unit 112 performs an edge detection on each of a plurality of blocks to be detected in an image frame so as to obtain edge detection information. The edge detection information may include related information indicating whether each pixel in each of the blocks to be detected is an edge pixel of a static logo.

In a specific embodiment of the step S200, it is determined whether each pixel in each of the blocks to be detected is an edge pixel of a plurality of specific edge directions. For example, for each of the pixels, it is determined whether the pixel is an edge pixel of a vertical direction, whether the pixel is an edge pixel of a horizontal direction, and whether the pixel is an edge pixel of an oblique direction.

Then, in step S202, the logo detection unit 112 performs motion estimation on a surrounding area of each of the blocks to be detected so as to obtain motion vectors of a plurality of blocks within the surrounding area, and obtain distribution information of the motion vectors within the surrounding area. In detail, a surrounding area of a block to be detected is composed of a plurality of blocks surrounding the block to be detected, and the distribution information of the motion vectors of the plurality of blocks may include respective directions and respective magnitudes of the motion vectors of the blocks. Moreover, it should be noticed that the steps S200 and S202 can be simultaneously executed or executed in a reverse sequence.

Then, in step S204, the logo detection unit 112 performs a static logo detection on the pixel blocks according to the edge detection information obtained in the step 5200 and the distribution information of motion vectors within the surrounding area that is obtained in the step S202, so as to determine whether the logo to be detected is a static logo. The logo detection unit 112 can determine whether the logo is the static logo according to a single image frame, and can also accumulate logo detection results of a plurality of image frames according to aforementioned method to determine whether the logo to be detected is the static logo. When it is determined whether the logo to be detected is the static logo, if a certain number of the blocks contained in the logo reaches are determined to be the blocks consisting the static logo, the logo can be determined to be the static logo.

According to the above descriptions, since the edge detection information of the block and the distribution information of the motion vectors of the surrounding area of the block are considered, the method for detecting the static logo of the present embodiment can increase correctness of the static logo detection, so as to avoid misjudgment.

It should be noticed that in the step S204, during the process that the logo detection unit 112 performs the static logo detection according to the edge detection information obtained in the step 5200, it is better to exclude the edge detection information of a specific moving direction, for example, exclude the edge detection information of the moving direction parallel to that of the block to be detected, or exclude the edge detection information of the moving direction parallel to that of a moving object crossing the block to be detected, so as to obtain an accurate static logo detection result.

In detail, assuming that a moving direction (or a moving direction of the above moving object) of a block to be detected is a horizontal direction, after the step S200 is performed in which the edge detection information of the horizontal direction, the vertical direction and the oblique direction of each pixel of the block to be detected are obtained, the logo detection unit 112 can exclude the edge detection information of the horizontal direction in determining whether each pixel of the block to be detected is the edge pixel of the static logo.

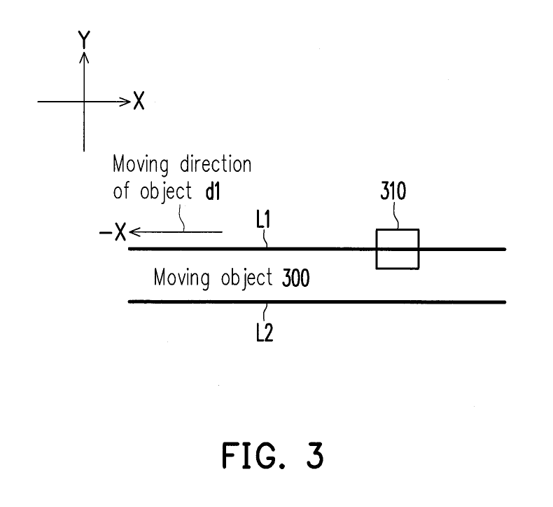

FIG. 3 is an example of how the logo detection unit uses the edge detection information in logo detection. Referring to FIG. 3, the image frame used for the logo detection includes a moving object 300 moving towards a −X direction, where L1 and L2 are edges of the moving object 300. Here, a moving direction dl of the moving object 300 is parallel to the edges L1 and L of the moving object 300. Moreover, a block 310 is one of the plurality of blocks calculated by the logo detection unit 120 during the logo detection, i.e. a block to be detected, and the block 310 is located on the edge L1 of the moving object 300.

As described above, in the step S204, in order to avoid misjudgment of a false static state, the logo detection unit 112 can exclude the edge detection information of the moving direction parallel to that of the moving object 300. In this example, since the moving direction dl is parallel to the edges L1 and L2 of the moving object 300, when the logo detection unit 112 performs the logo detection, the logo detection unit 112 determines whether the logo to be detected is the static logo without referring to the edge detection information of the moving direction parallel to the moving direction dl of the moving object 300. In other words, the logo detection unit 112 determines whether the logo to be detected is the static logo with reference of the edge detection information of the moving direction that is not parallel to the moving direction dl of the moving object 300.

For example, in the step 5200, the obtained edge detection information includes related information indicating whether each pixel in the block 310 is an edge pixel of the vertical direction, an edge pixel of the horizontal direction or an edge pixel of the oblique direction. Then, in the step S204, if the pixel is not at least one of the edge pixels of the three directions, or the pixel is only determined to be the edge pixel of the horizontal direction, the pixel is not regarded as an edge pixel of the static logo. In other words, only when the pixel is determined to be the edge pixel of the vertical direction and/or the edge pixel of the oblique direction, the pixel is regarded as the edge pixel of the static logo.

It should be noticed that during a process that the logo detection unit 112 detects the moving direction d1 of the moving object 300, the logo detection unit 112 may calculate a background vector of the block 310 to represent the moving direction dl of the moving object 300. In some embodiments, a global motion vector of the image frame can be used to represent the background vector. Moreover, the background vector can be calculated by excluding vector information of a background other than a target object (i.e. the static logo) in the image frame. For example, the calculated global motion vector is (−10,0), which represents that the moving direction of the moving object 300 is leftward (−X), and a magnitude thereof is 10. It should be noticed that the global motion vector is not limited to a motion vector of a major count of the whole frame obtained through statistics, which can also be a motion vector of the majority of the blocks in a selected area during the logo detection, where the selected area can be an adjustable area greater than the static logo.

According to the above descriptions, the logo detection unit 112 can determine correctness of the logo detection through the object moving direction and an edge structure of the moving object. The edge parallel to the moving direction may be excluded from edge calculation of the static logo, so as to avoid false judgment of the static state.

Moreover, in the step S204, during a process that the logo detection unit 112 detects the static logo according to the distribution information of the motion vectors, if it is detected that directions of the motion vectors of the surrounding area of the block are similar, or the motion vectors are very small, preferably, the block can be excluded. In other words, the block is not regarded as a block of the static logo. In this way, a more accurate static logo detection result is obtained.

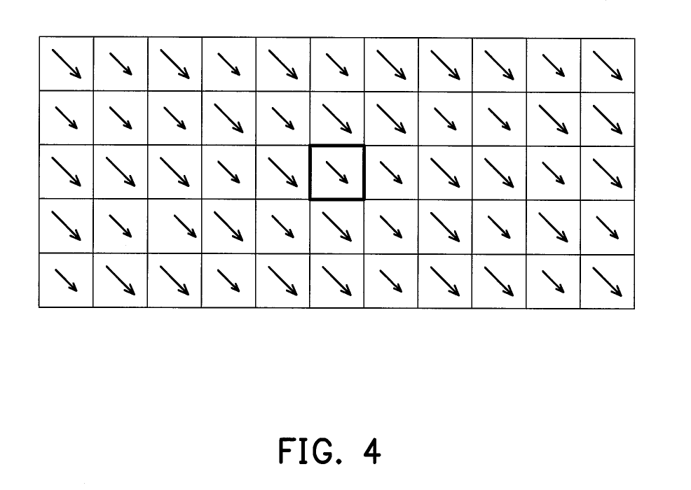

FIG. 4 is an example of how the logo detection unit uses the distribution information of motion vectors of the surrounding area in logo detection. Referring to FIG. 4, in the present embodiment, a number of the blocks selected by the logo detection unit 112 is, for example, 11×5, i.e. 11 columns of blocks along the horizontal direction are selected, and 5 columns of blocks along the vertical direction are selected to serve as an image area of the logo detection, though the disclosure is not limited thereto, and the selected blocks include a block to be detected (shown by a thick black-rimmed block of FIGS. 4), and 54 blocks within a surrounding area of the block to be detected.

In the step S202, the logo detection unit 112 performs the motion estimation on the selected blocks to obtain a motion vector corresponding to each of the blocks, as that shown in FIG. 4. In FIG. 4, an arrow shown in each block represents a direction and a magnitude of the corresponding motion vector.

After the motion vectors of the blocks within the surrounding area of the block to be detected are obtained, the logo detection unit 112 determines whether the magnitudes of most (for example, more than 70% or 80%) of the motion vectors of the blocks are smaller than a specific threshold, so as to determine whether the block to be detected is a block of the static logo. In FIG. 4, since 70%-80% of the motion vector distribution of the block to be detected is smaller than the specific threshold, the logo detection unit 112 can exclude the detected block, i.e. the detected block is not regarded as a block of the static logo. It should be noticed that, in the present embodiment, the magnitudes of 70%-80% of the motion vectors of the blocks are smaller than the specific threshold, though the ratios 70%-80% are not used to limit the disclosure. Moreover, the logo detection unit 112 can determine the specific threshold according to the global motion vector.

In the present embodiment, a magnitude of each of the motion vectors is used as a determination basis in logo detection. However, in other embodiment, the logo detection unit 112 can also determine whether the logo to be detected is the static logo according to a direction of each of the motion vectors.

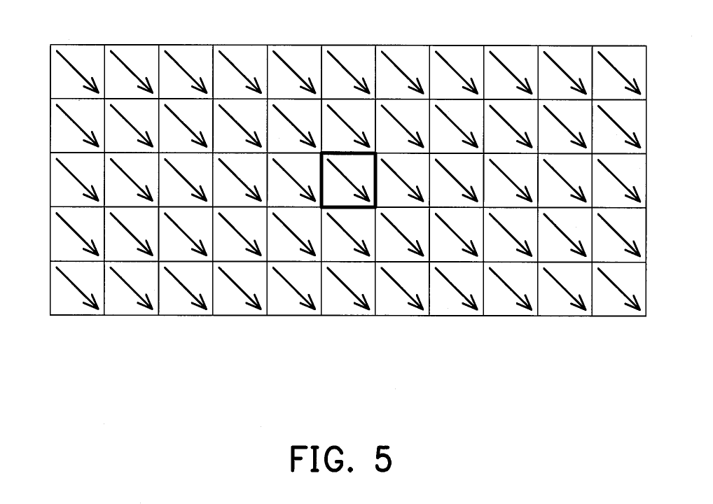

FIG. 5 is another example of how the logo detection unit uses the distribution information of motion vectors of the surrounding area in logo detection. Referring to FIG. 5, since 90%-95% of the directions of the motion vectors of the blocks in the surrounding area of the block to be detected substantially point to a same direction, the logo detection unit can exclude the block to be detected, i.e. the block to be detected is not regarded as a block of the static logo.

It should be noticed that, with respect to measuring whether the motion vectors point to substantially the same direction, in the present example, a condition that the motion vectors of 90%-95% of the blocks substantially point to the same direction is taken as an example for descriptions, though the ratios 90%-95% are not used to limit the disclosure, and in other embodiments, other ratios can be used. Moreover, the so called “substantially point to the same direction” may mean that an angle difference of the motion vectors is within a specific difference range.

In summary, in the method for detecting the static logo, the logo detection unit performs the logo detection by using the edge detection information and the distribution information of motion vectors of the surrounding area as a determination basis, so that accuracy of the logo detection is increased to avoid misjudgment.

It should be noticed that in other embodiments, it is unnecessary to simultaneously use the edge detection information and the distribution information of motion vectors of the surrounding area in order to determine the static logo. In the other embodiments, only the edge detection information is probably obtained to determine the static logo. For example, an edge which is parallel to the moving direction of the block to be detected or the moving object is filtered. Alternatively, in other embodiments, only the distribution information of motion vectors within the surrounding area of the block to be detected is used to determine the static logo. For example, if the motion vectors within the surrounding area of the block to be detected are detected to be similar or very small, the block to be detected can be excluded.

It will be apparent to those skilled in the art that various modifications and variations can be made to the structure of the disclosure without departing from the scope or spirit of the disclosure. In view of the foregoing, it is intended that the disclosure cover modifications and variations of this invention provided they fall within the scope of the following claims and their equivalents.

What is claimed is:

1. A method for detecting a static logo, comprising:
performing an edge detection on each of a plurality of blocks to be detected in an image frame, so as to obtain edge detection information;
performing a motion estimation on a plurality of blocks within a respective surrounding area of each of the blocks to be detected, so as to obtain distribution information of motion vectors; and
determining whether a logo to be detected in the image frame is a static logo according to the edge detection information and the distribution information of the motion vectors.

2. The method for detecting the static logo as claimed in claim 1, wherein the step of determining whether the logo to be detected is the static logo comprises:
excluding the edge detection information of a moving direction parallel to that of each of the blocks to be detected.

3. The method for detecting the static logo as claimed in claim 2, wherein the step of determining whether the logo to be detected is the static logo comprises:
excluding the edge detection information of a moving direction parallel to that of a moving object comprising the block to be detected.

4. The method for detecting the static logo as claimed in claim 2, wherein the step of determining whether the logo to be detected is the static logo comprises:
determining whether magnitudes of the motion vectors of the plurality of blocks within the surrounding area of the block to be detected are respectively smaller than a specific threshold; and
if yes, excluding the block to be detected.

5. The method for detecting the static logo as claimed in claim 1, wherein the step of determining whether the logo to be detected is the static logo comprises:
determining whether directions of the motion vectors of the plurality of blocks within the surrounding area of the block to be detected substantially point to a same direction; and
if yes, excluding the block to be detected.

6. The method for detecting the static logo as claimed in claim 1, wherein the edge detection information comprises information indicating whether a plurality of pixels in each of the blocks to be detected are edge pixels of a plurality of specific edge directions.

7. The method for detecting the static logo as claimed in claim 6, wherein the step of determining whether the logo to be detected is the static logo comprises:
determining a pixel to be not an edge pixel when the pixel in the block to be detected is not at least one of the edge pixels of the specific edge directions.

8. The method for detecting the static logo as claimed in claim 6, wherein the step of determining whether the logo to be detected is the static logo comprises:
determining the pixel to be an edge pixel when the specific edge directions are all non-parallel to a specific moving direction in case that the pixel is at least one of the edge pixels of the specific edge directions.

9. The method for detecting the static logo as claimed in claim 8, wherein the specific moving direction is a moving direction of the block to be detected or a moving direction of a moving object crossing the block to be detected.

10. The method for detecting the static logo as claimed in claim 6, wherein the step of determining whether the logo to be detected is the static logo comprises:
determining the pixel to be not an edge pixel when the specific edge directions are parallel to a specific moving direction in case that the pixel is only one of the edge pixels of the specific edge directions.
